(19) United States
(12) Patent Application Publication
(10) Pub. No.: US 2011/0081876 A1
(43) Pub. Date: Apr. 7, 2011

(54) DEVICE WITH DUAL-BAND ANTENNA TUNED BY TANK NETWORK

(75) Inventors: Michael Kuehn, Bochum (DE); Andreas Handro, Bochum (DE)

(73) Assignee: RESEARCH IN MOTION LIMITED, Waterloo (CA)

(21) Appl. No.: 12/722,740

(22) Filed: Mar. 12, 2010

Related U.S. Application Data
(60) Provisional application No. 61/248,732, filed on Oct. 5, 2009.

(51) Int. Cl. H04B 1/04

(52) U.S. Cl. 455/103

(57) ABSTRACT

A communication device having an antenna tuned by a tank network at its input port to realize dual-band resonance. The antenna alone has a wideband but weak resonance, while the device antenna circuit with the tank network has a narrowband resonance between the two desired frequencies when the antenna is open-circuited. Together, the device antenna circuit with the tank network and antenna realize dual narrowband resonance at the two desired frequencies.

### CROSS-REFERENCE TO RELATED APPLICATIONS

The present application claims priority to U.S. Application No. 61/248,732, filed Oct. 5, 2009. Said application is expressly incorporated herein by reference in its entirety.

### FIELD

The present application generally relates to electronic communications devices having dual-band antennas and, in particular, to a device having a dual-band antenna tuned by a tank network.

### BACKGROUND

Modern mobile communications devices are often equipped to operate on more than one frequency band. For example, some devices are capable of communicating on GSM-850 and GSM-1900. Yet other devices are capable of communication on GSM-900 and GSM-1800.

In addition, modern mobile communications devices are often multi-mode devices configured to communicate in more than one mode. For example, a multi-mode device may be configured to communicate with WWAN (wireless wide area networks) in accordance with standards such as GSM, EDGE, 3GPP, UMTS, etc., and may further be configured to communicate with WLAN (wireless local area networks) in accordance with standards like IEEE 802.11. Yet other devices incorporate antennas for satellite communications, such as GPS. Some devices are also equipped for short-range communications such as Bluetooth®. The multi-functionality of these devices often requires multiple antennas within the devices in order to communicate over the various frequency bands.

At the same time, the form factors for mobile communications devices are increasingly sleek and compact. This puts space within the device at a premium and makes it difficult to accommodate multiple antennas. Accordingly, compact antennas that are capable of operating on more than one frequency band are desirable.

It would be advantageous to provide for an antenna that has a low profile but is capable of operating on more than one frequency band.

### BRIEF DESCRIPTION OF THE DRAWINGS

Reference will now be made, by way of example, to the accompanying drawings which show example embodiments of the present application, and in which:

FIG. 1 shows one embodiment of a electronic device having a dual-band antenna;

FIG. 2 shows an S11return loss plot for the antenna of FIG. 1 alone;

FIG. 3 shows an S11return loss plot for the device of FIG. 1 with the antenna open-circuited;

FIG. 4 shows an S11return loss plot for the device of FIG. 1;

FIG. 5 shows an embodiment of the antenna for the device of FIG. 1;

FIG. 6 shows a specific embodiment of the device of FIG. 1 having the antenna of FIG. 5;

FIGS. 7 through 16 shows S11plots and Smith charts for various configurations of the device of FIG. 6; and

FIG. 17 shows a block diagram of one embodiment of an exemplary mobile communications device.

Similar reference numerals may have been used in different figures to denote similar components.

### DESCRIPTION OF EXAMPLE EMBODIMENTS

In one aspect, the present application describes a device having an antenna tuned by a tank network at its input port to realize dual-band resonance. The antenna alone has a wideband but weak resonance, while the device antenna circuit with the tank network has a narrowband resonance between the two desired frequencies when the antenna is open-circuited. Together, the device antenna circuit with the tank network and antenna realize dual narrowband resonance at the two desired frequencies. The physical characteristics of the antenna and the values of the components in the tank network determine the dual-band resonance and may be altered or adjusted to tune the dual-band resonance to the desired frequency pair.

In one aspect, the present application discloses a mobile communication device that includes an RF circuit; an antenna having a feed point coupled to the RF circuit by a transmission line; and a tank circuit, including an inductor and a capacitor connected in parallel between the transmission line and an RF ground. The antenna and tank circuit together comprise a matched antenna with two resonant frequencies.

In some embodiments, the antenna is a monopole radiator. In some embodiments, the monopole radiator is a microstrip antenna with a single feed point. In some embodiments, the microstrip antenna includes a planar strip and a capacitive patch at an end of the planar strip opposite from the feed point. In yet other embodiments, the antenna is printed upon a flexible substrate.

In yet another aspect, the present application describes a mobile communication device. The device includes a memory; a processor; an RF transceiver for sending and receiving RF modulated communications; an antenna having a feed point coupled to the RF circuit by a transmission line; and a tank circuit. The tank circuit includes an inductor and a capacitor connected in parallel between the transmission line and an RF ground. The antenna and tank circuit together form a matched antenna with two resonant frequencies. The antenna is a monopole microstrip antenna having a wideband frequency response in isolation, the wideband frequency response including the two resonant frequencies, and the tank circuit and RF circuit have a resonant frequency between the two resonant frequencies when the antenna is open-circuited.

Other aspects and features of the present application will be apparent to those of ordinary skill in the art from a review of the following description in conjunction with the figures.

Many electronic devices include an antenna for radio frequency communications, including mobile devices, laptop computers, desktop computers, smartphones, personal digital assistants, and many other such devices. Multi-mode or multi-band devices are configured to operate on more than one frequency band. Accordingly, such devices require more than one antenna or at least one antenna that is capable of operating on more than one frequency band. Many devices, for example, have one or more antennas tuned to cellular bands, such as GSM bands. These devices may also have antennas tuned to bands used for other types of communications, such as WLAN, GPS, or Bluetooth®, for example. In order to conserve space within the device, it is desirable to have a single antenna function for two or more bands.

Reference is now made to FIG. 1, which diagrammatically illustrates an example embodiment of a mobile communications device 10. In this embodiment, the device 10 includes an antenna 12 and a radio frequency (RF) transceiver 14. In some embodiments, the antenna 12 may be intended for only transmission or reception functions, in which case the transceiver in such embodiments may be an RF transmitter or RF receiver, as the case may be.

The antenna 12 in this embodiment has a single feed point. The antenna 12, on its own, has a wideband but somewhat weak resonance. In other words, it has a relatively flat return loss at the feed point. The antenna 12 in this embodiment is a low profile configuration, such as a microstrip or patch antenna. Other types of antennas may be used in other embodiments.

The weak but wide resonance of the antenna 12 alone includes two desired operating frequencies. In other words, the physical characteristics of the antenna 12 are selected such that the resulting wideband frequency response of the antenna 12 includes the two desired operating frequencies.

The transceiver 14 in this embodiment generates RF signals to drive the antenna 12 when transmitting and it receives RF signals induced in the antenna 12 when receiving. The antenna 12 is connected to the transceiver 14 by a transmission line 16. The transmission line 16 may include any conductive path for transmitting RF signals between the antenna 12 and the transceiver 14, including a PCB signal trace line, a coaxial cable, a trace line within a flex cable, and any other conductive signal path, including combinations of these possibilities.

The device 10 includes a tank circuit 20 connected to the input of the antenna 12. The tank circuit 20 is formed from an inductor 22 and a capacitor 24 connected in parallel between the transmission line 16 and an RF ground. The RF ground may be a system or device ground plane, for example.

The tank circuit 20 and antenna 12 together have a dual band resonance at the two desired operating frequencies. In other words, the tank circuit 20, which may be referred to as a matching circuit, serves to tune the antenna 12 to resonate at the two desired operating frequencies. The tank circuit 20 and antenna 12 together form a matched antenna with two resonant frequencies.

The values of the inductor 22 and capacitor 24 are selected through trial-and-error or simulation, and are dependent upon the two desired operating frequencies and the characteristics of the antenna 12.

It will be appreciated that the device 10 includes a number of other components not depicted in FIG. 1 for clarity, including a processor, memory, power source, input device, display device, and other components.

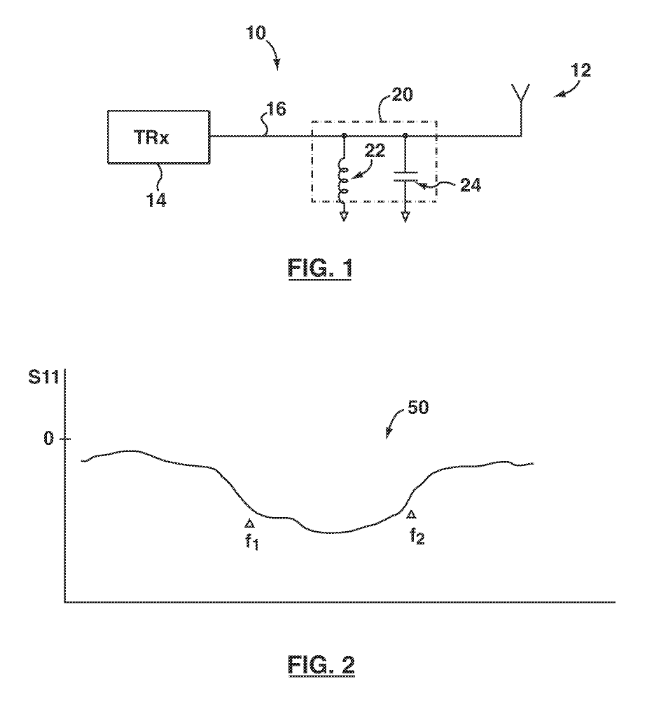

Reference is now made to FIGS. 2 through 4, which show return loss plots for various combinations of elements from FIG. 1. In particular, FIG. 2 shows a return loss plot 50 for the antenna 12 without the tank circuit 20. It will be noted that the S11or return loss plot 50 without the tank circuit 20 indicates a shallow and wide frequency response. The two desired frequencies f₁ and f₂ are indicated on the plot 50.

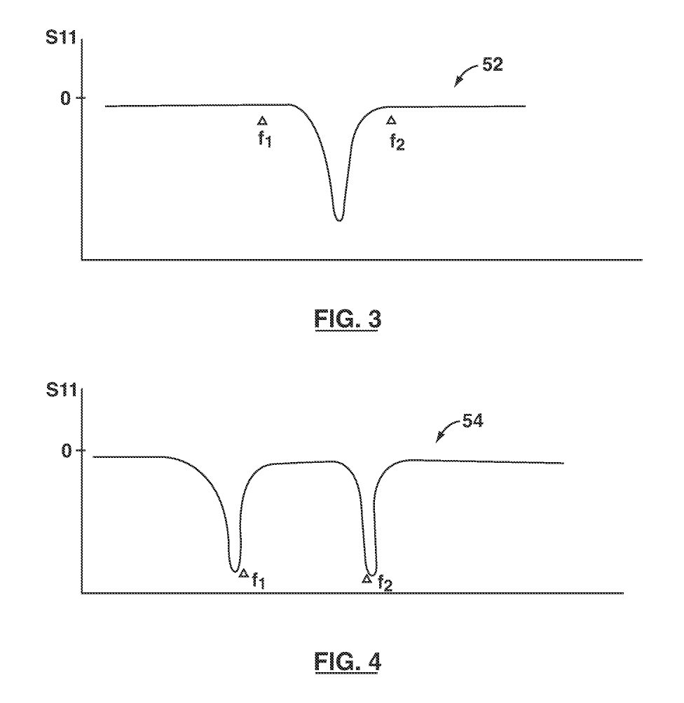

FIG. 3 shows a return loss plot 52 for the device 10 if the tank circuit 20 is included but the antenna 12 is open-circuited. The return loss plot 52 indicates a resonance between the two desired frequencies f₁ and f₂.

FIG. 4 shows a return loss plot 54 for the device 10 as depicted in FIG. 1. The return loss plot 54 shows that the antenna 12 and tank circuit 20 in combination result in dual-band resonance at the two desired frequencies f₁ and f₂. It will be appreciated that the selection of values for the inductor 22 and capacitor 24 tunes the location of the resonances shown in FIG. 4.

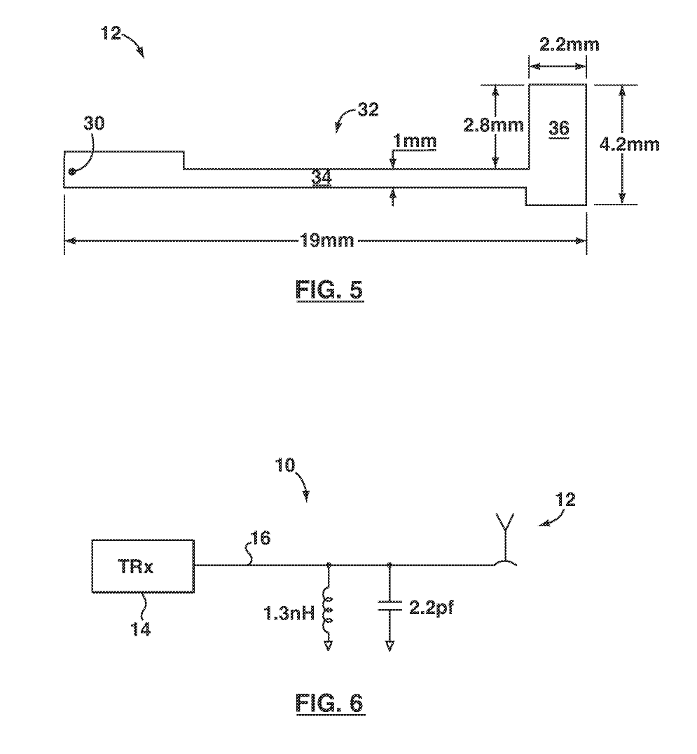

Reference is now made to FIG. 5, which diagrammatically shows one embodiment of the antenna 12 from FIG. 1. In this embodiment, the antenna 12 is a monopole microstrip antenna. The antenna 12 is formed from a conductive metal, such as copper, gold, etc. The antenna 12 may be printed on a flexible substrate having an adhesive on one side. The flexible substrate with the printed antenna 12 may then be adhered to an internal or external surface of the device 10.

The antenna 12 includes a feed point 30 and a radiator arm 32. The feed point 30 may include a soldered connection to the transmission line 16 (FIG. 1) in some embodiments. In yet other embodiments, other mechanisms may used to connect the transmission line 16 to the feed point 30. For example, the device 10 (FIG. 1) may include a spring contact or other such connector for electrically connecting the transmission line 16 to the feed point 30. Other connectors will be apparent to those ordinarily skilled in the art having regard to the present description.

The radiator arm 32, in this embodiment, includes a planar strip 34 having the feed point 30 at one end and a patch 36 at the other end. The patch 36 is a rectangular portion of the microstrip having a larger width than the planar strip 34. In some configurations, the patch 36 may provide a capacitive effect and may tune the frequency response of the antenna 12.

In one example implementation, the device 10 (FIG. 1) and antenna 12 are intended for use in a mobile handheld communications device having multiple antennas. The antenna 12 in this embodiment is intended for use in both GPS and WLAN applications. Accordingly, the two operating frequencies f₁ and f₂ for the antenna 12 in this example are approximately between 1.5-1.6 GHz and 2.4-2.5 GHz and, specifically, 1.575 GHz and 2.45 GHz, respectively. For this example implementation, the antenna 12 has the approximate dimensions indicated in FIG. 5. That is the overall length of the radiator arm 32 (including the patch 36) is about 19 mm, with a width of about 1 mm. The patch is about 2.2 mm long and 4.2 mm wide, extending about 2.8 mm from one edge of the planar strip 34 and about 0.4 mm from the other edge.

Reference is now made to FIG. 6, which shows the device 10 of FIG. 1 for the example implementation at 1.575 GHz and 2.45 GHz. The device 10 of FIG. 6 includes the antenna 12 of FIG. 5 having the dimensions set out above. In this example, to provide the device 10 with dual band resonance at the desired frequencies, the inductor 22 has a value of 1.3 nH and the capacitor 24 has a value of 2.2 pF. The present applicants have found that this configuration results in dual band resonance at 1.575 GHz and 2.45 GHz.

It will be understood that these are example values selected based upon the dimensions and characteristics of the antenna 12 and the desired operating frequencies f₁ and f₂. In other implementations, different values may be selected because of an antenna having different characteristics or because different operating frequencies are desired. Somewhat similar antenna dimensions and component values may results in desired operating frequencies f₁ and f₂ of approximately between 1.5-1.6 GHz and 2.4-2.5 GHz.

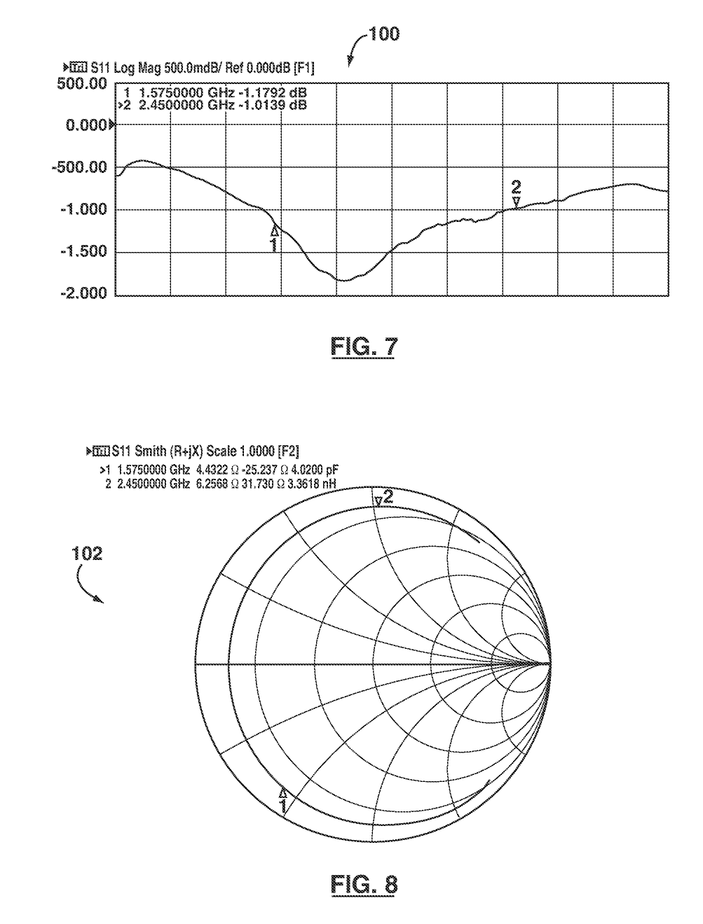

Reference will now also be made to FIGS. 7 through 16, which detail simulation and/or test results for the example device 10 of FIGS. 5 and 6.

FIGS. 7 and 8 show an S11S11plot (return loss plot) 100 and Smith chart 102, respectively, for the antenna 12 alone. In other words, FIGS. 7 and 8 demonstrate the wideband and weak resonance of the antenna 12 on its own. This is particularly evident from FIG. 7, where it can be seen that the return loss never reaches −2 dB, and is around −1 dB for the two desired frequencies at 1.575 GHz and 2.45 GHz. Nevertheless, the antenna 12 wideband frequency response incorporates the two desired operating frequencies.

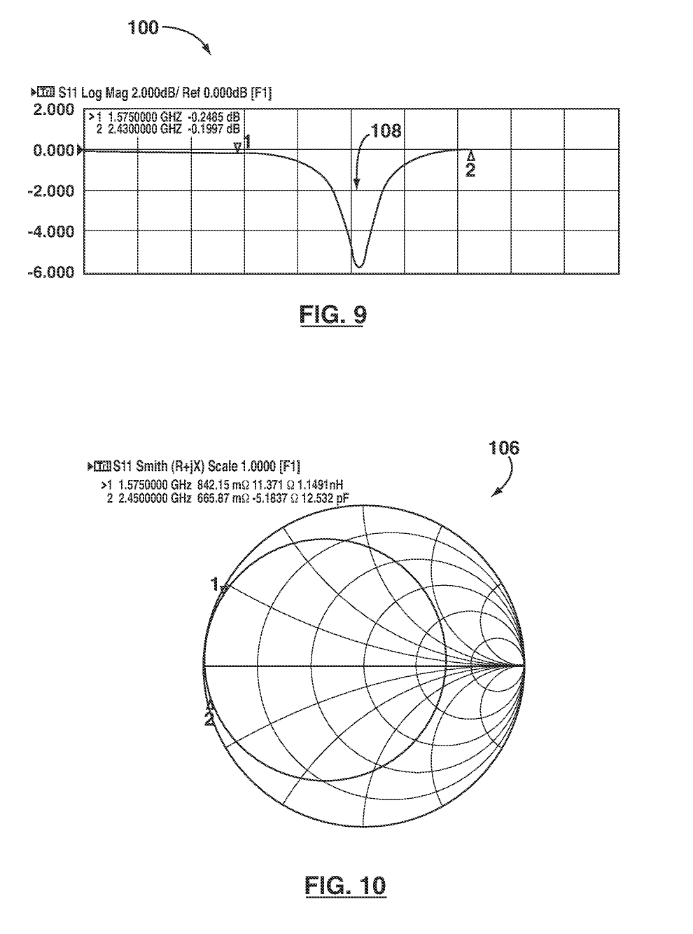

FIGS. 9 and 10 show an S11plot (return loss plot) 104 and Smith chart 106, respectively, for the device 10 with the tank circuit 20 included but with the antenna port open, i.e. with the antenna disconnected. Here it will be noted that the tank circuit 20 results in a resonance between the two desired frequencies, as indicated by reference 108.

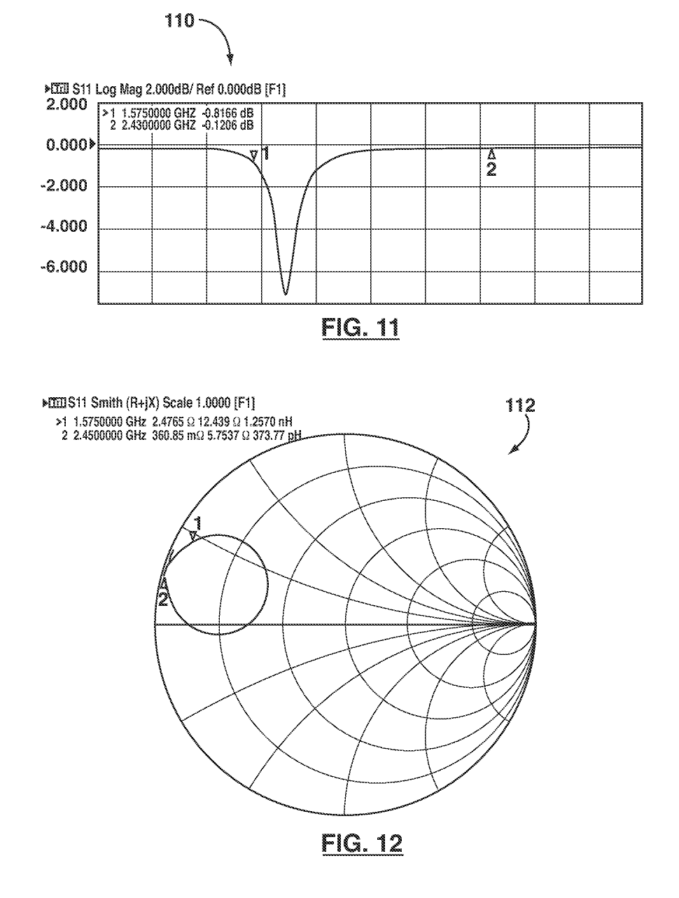

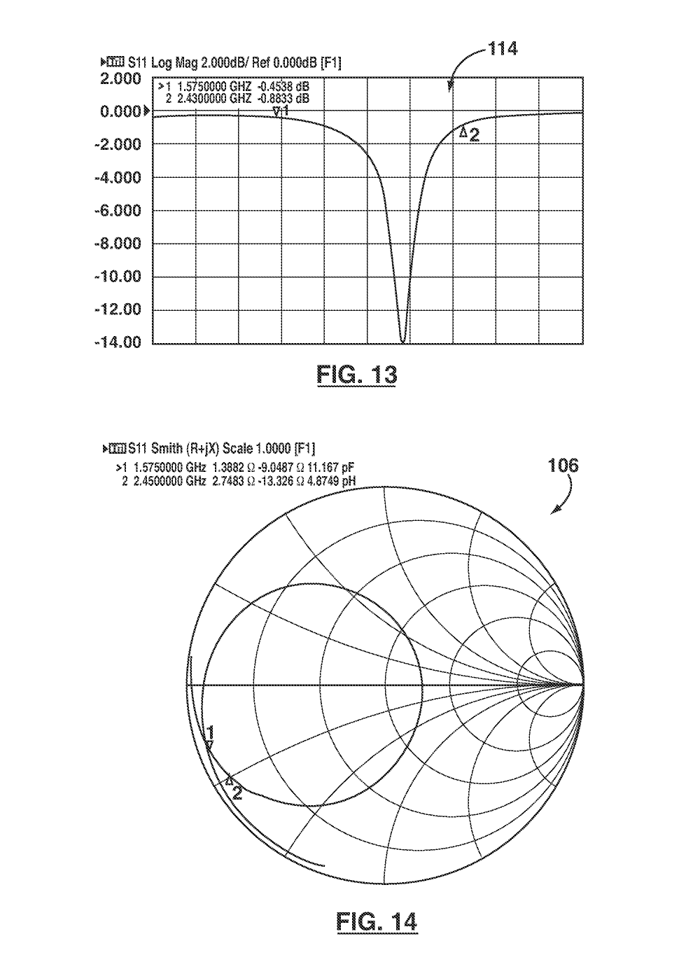

FIGS. 11 to 14 illustrate the effect of the tank circuit 20. FIGS. 11 and 12 show an S11plot (return loss plot) 110 and Smith chart 112, respectively, for the device 10 with the inductor 22 of the tank circuit 20 connected, but the capacitor 24 disconnected. It will be appreciated, in particular, from the S11plot 110 that the influence of the inductor 22 is to push the resonance of the antenna 12/inductor 22 towards the first desired frequency f₁. FIGS. 13 and 14 show an S11plot 114 and Smith chart 116, respectively, for the device 10 with the capacitor 24 of the tank circuit 20 connected, but the inductor 22 disconnected. It will be appreciated that the influence of the capacitor 24 is to push the resonance of the antenna 12/capacitor 24 towards the second desired frequency f₂.

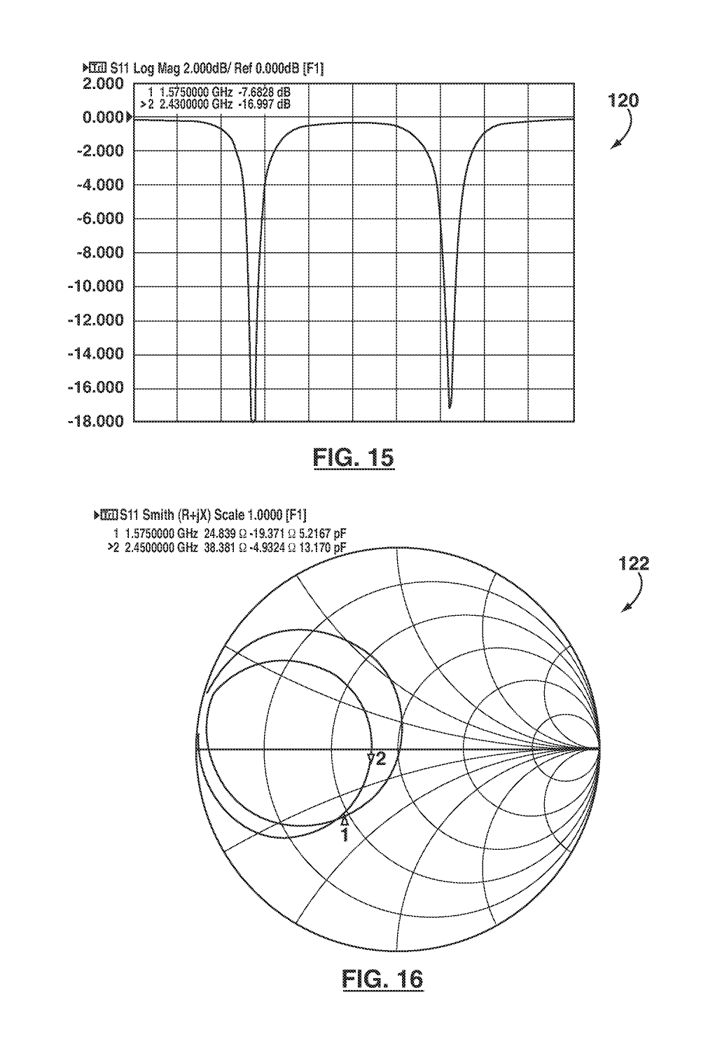

FIGS. 15 and 16 depict an S11plot 120 and Smith chart 122, respectively, for the device 10 with the tank circuit 20 connected as depicted in FIG. 5. It will be appreciated that the resulting resonance is a strong dual-band frequency response centered approximately at the two desired frequencies, 1.575 GHz and 2.45 GHz.

It will be appreciated form the foregoing discussion with regard to FIGS. 5 through 16 that the illustrated embodiment is suitable for dual-mode use as a GPS and WLAN device.

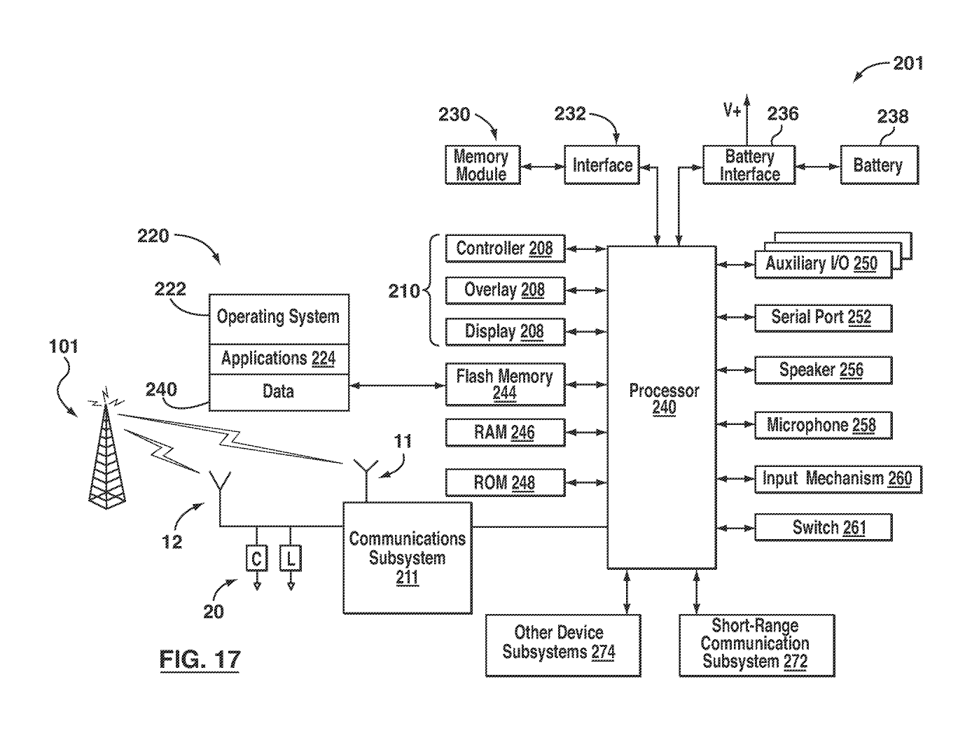

Reference is now made to FIG. 17, which shows an example embodiment of a mobile communication device 201 which may incorporate the antenna 12 and tank circuit 20 described herein. The mobile device communication device 201 may also have one or more other antennas, such as antenna 11.

The mobile communication device 201 is a two-way communication device having voice and possibly data communication capabilities; for example, the capability to communicate with other computer systems, e.g., via the Internet. Depending on the functionality provided by the mobile communication device 201, in various embodiments the device may be a multiple-mode communication device configured for both data and voice communication, a smartphone, a mobile telephone or a PDA (personal digital assistant) enabled for wireless communication, or a computer system with a wireless modem.

The mobile communication device 201 includes a controller comprising at least one processor 240 such as a microprocessor which controls the overall operation of the mobile communication device 201, and a wireless communication subsystem 211 for exchanging radio frequency signals with the wireless network 101 or other networks or devices. The processor 240 interacts with the communication subsystem 211 which performs communication functions. The processor 240 interacts with additional device subsystems. In some embodiments, the device 201 may include a touchscreen display 210 which includes a display (screen) 204, such as a liquid crystal display (LCD) screen, with a touch-sensitive input surface or overlay 206 connected to an electronic controller 208. The touch-sensitive overlay 206 and the electronic controller 208 provide a touch-sensitive input device and the processor 240 interacts with the touch-sensitive overlay 206 via the electronic controller 208. In other embodiments, the display 204 may not be a touchscreen display. Instead, the device 201 may simply include a non-touch display and one or more input mechanisms, such as, for example, a depressible scroll wheel.

The processor 240 interacts with additional device subsystems including flash memory 244, random access memory (RAM) 246, read only memory (ROM) 248, auxiliary input/output (I/O) subsystems 250, data port 252 such as serial data port, such as a Universal Serial Bus (USB) data port, speaker 256, microphone 258, input mechanism 260, switch 261, short-range communication subsystem 272, and other device subsystems generally designated as 274. Some of the subsystems shown in FIG. 17 perform communication-related functions, whereas other subsystems may provide “resident” or on-device functions.

The communication subsystem 211 may include a receiver, a transmitter, and associated components, such as the antennas 11 and 12, other antennas, local oscillators (LOs), and a processing module such as a digital signal processor (DSP). The antennas 11 and 12 may be embedded or internal to the mobile communication device 201 and a single antenna may be shared by both receiver and transmitter, as is known in the art. As will be apparent to those skilled in the field of communication, the particular design of the communication subsystem 211 depends on the wireless network 101 in which the mobile communication device 201 is intended to operate. In one example embodiment, the antenna 11 is configured to operate in at least a first frequency range, such as GSM-900, GSM-850, etc., and to operate in at least a second frequency range, such as bands for UMTS/3 G communications, like 1710-2170 MHz. By “range”, the present application refers to the broad set of frequency bands (both uplink and downlink) intended to be used for wireless communications conforming to a particular standard. In one example embodiment, the antenna 12 and tank circuit 20 are configured to have two resonant frequencies. For example, at approximately 1.575 GHz and 2.45 GHz, and may be used for GPS and WLAN communications.

The mobile communication device 201 may communicate with any one of a plurality of fixed transceiver base stations of a wireless network 101 within its geographic coverage area. The mobile communication device 201 may send and receive communication signals over the wireless network 101 after a network registration or activation procedures have been completed. Signals received by the antenna 11 or the antenna 12 through the wireless network 101 are input to the receiver, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP. In a similar manner, signals to be transmitted are processed, including modulation and encoding, for example, by the DSP. These DSP-processed signals are input to the transmitter for digital-to-analog (D/A) conversion, frequency up conversion, filtering, amplification, and transmission to the wireless network 101 via the antenna 11 or the antenna 12.

The processor 240 operates under stored program control and executes software modules 220 stored in memory such as persistent memory, for example, in the flash memory 244. As illustrated in FIG. 17, the software modules 220 comprise operating system software 222 and software applications 224.

Those skilled in the art will appreciate that the software modules 220 or parts thereof may be temporarily loaded into volatile memory such as the RAM 246. The RAM 246 is used for storing runtime data variables and other types of data or information, as will be apparent to those skilled in the art. Although specific functions are described for various types of memory, this is merely one example, and those skilled in the art will appreciate that a different assignment of functions to types of memory could also be used.

The software applications 224 may include a range of other applications, including, for example, a messaging application, a calendar application, and/or a notepad application. In some embodiments, the software applications 224 include an email message application, a push content viewing application, a voice communication (i.e. telephony) application, a map application, and a media player application. Each of the software applications 224 may include layout information defining the placement of particular fields and graphic elements (e.g. text fields, input fields, icons, etc.) in the user interface (i.e. the display device 204) according to the application.

In some embodiments, the auxiliary input/output (I/O) subsystems 250 may comprise an external communication link or interface, for example, an Ethernet connection. The mobile communication device 201 may comprise other wireless communication interfaces for communicating with other types of wireless networks, for example, a wireless network such as an orthogonal frequency division multiplexed (OFDM) network or a GPS transceiver for communicating with a GPS satellite network, for example through antenna 12. The auxiliary I/O subsystems 250 may comprise a vibrator for providing vibratory notifications in response to various events on the mobile communication device 201 such as receipt of an electronic communication or incoming phone call, or for other purposes such as haptic feedback (touch feedback).

In some embodiments, the mobile communication device 201 also includes a removable memory card 230 (typically comprising flash memory) and a memory card interface 232. Network access may be associated with a subscriber or user of the mobile communication device 201 via the memory card 230, which may be a Subscriber Identity Module (SIM) card for use in a GSM network or other type of memory card for use in the relevant wireless network type. The memory card 230 is inserted in or connected to the memory card interface 232 of the mobile communication device 201 in order to operate in conjunction with the wireless network 101.

The mobile communication device 201 stores data 240 in an erasable persistent memory, which in one example embodiment is the flash memory 244. In various embodiments, the data 240 includes service data comprising information required by the mobile communication device 201 to establish and maintain communication with the wireless network 101. The data 240 may also include user application data such as email messages, address book and contact information, calendar and schedule information, notepad documents, image files, and other commonly stored user information stored on the mobile communication device 201 by its user, and other data. The data 240 stored in the persistent memory (e.g. flash memory 244) of the mobile communication device 201 may be organized, at least partially, into a number of databases each containing data items of the same data type or associated with the same application.

The serial data port 252 may be used for synchronization with a user's host computer system (not shown). The serial data port 252 enables a user to set preferences through an external device or software application and extends the capabilities of the mobile communication device 201 by providing for information or software downloads to the mobile communication device 201 other than through the wireless network 101. The alternate download path may, for example, be used to load an encryption key onto the mobile communication device 201 through a direct, reliable and trusted connection to thereby provide secure device communication.

In some embodiments, the mobile communication device 201 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their mobile communication device 201 to the host computer system via a USB cable or Bluetooth® connection, traffic that was destined for the wireless network 101 is automatically routed to the mobile communication device 201 using the USB cable or Bluetooth® connection. Similarly, any traffic destined for the wireless network 101 is automatically sent over the USB cable Bluetooth® connection to the host computer system for processing.

The mobile communication device 201 also includes a battery 238 as a power source, which is typically one or more rechargeable batteries that may be charged, for example, through charging circuitry coupled to a battery interface such as the serial data port 252. The battery 238 provides electrical power to at least some of the electrical circuitry in the mobile communication device 201, and the battery interface 236 provides a mechanical and electrical connection for the battery 238. The battery interface 236 is coupled to a regulator (not shown) which provides power V+ to the circuitry of the mobile communication device 201.

The short-range communication subsystem 272 is an additional optional component which provides for communication between the mobile communication device 201 and different systems or devices, which need not necessarily be similar devices. For example, the subsystem 272 may include an infrared device and associated circuits and components, or a wireless bus protocol compliant communication mechanism such as a Bluetooth® communication module to provide for communication with similarly-enabled systems and devices.

A predetermined set of applications that control basic device operations, including data and possibly voice communication applications will normally be installed on the mobile communication device 201 during or after manufacture. Additional applications and/or upgrades to the operating system 221 or software applications 224 may also be loaded onto the mobile communication device 201 through the wireless network 101, the auxiliary I/O subsystem 250, the serial port 252, the short-range communication subsystem 272, or other suitable subsystem 274 other wireless communication interfaces. The downloaded programs or code modules may be permanently installed, for example, written into the program memory (i.e. the flash memory 244), or written into and executed from the RAM 246 for execution by the processor 240 at runtime. Such flexibility in application installation increases the functionality of the mobile communication device 201 and may provide enhanced on-device functions, communication-related functions, or both. For example, secure communication applications may enable electronic commerce functions and other such financial transactions to be performed using the mobile communication device 201.

The wireless network 101 may comprise one or more of a Wireless Wide Area Network (WWAN) and a Wireless Local Area Network (WLAN) or other suitable network arrangements. In some embodiments, the mobile communication device 201 is configured to communicate over both the WWAN and WLAN, and to roam between these networks. In some embodiments, the wireless network 101 may comprise multiple WWANs and WLANs. In some embodiments, the mobile device 201 includes the communication subsystem 211 for WWAN communications and a separate communication subsystem for WLAN communications. In most embodiments, communications with the WLAN employ a different antenna than communications with the WWAN, although not necessarily. Accordingly, the antenna 11 may be configured for WWAN communications and the antenna 12 may be configured for WLAN communications depending on the embodiment and desired application.

In some embodiments, the WWAN conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX), or various other networks. Although WWAN is described as a “Wide-Area” network, that term is intended herein also to incorporate wireless Metropolitan Area Networks (WMAN) and other similar technologies for providing coordinated service wirelessly over an area larger than that covered by typical WLANs.

The WLAN comprises a wireless network which, in some embodiments, conforms to IEEE 802.11x standards (sometimes referred to as Wi-Fi) such as, for example, the IEEE 802.11a, 802.11b and/or 802.11g standard. Other communication protocols may be used for the WLAN in other embodiments such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN includes one or more wireless RF Access Points (AP) that collectively provide a WLAN coverage area.

Certain adaptations and modifications of the described embodiments can be made. Therefore, the above discussed embodiments are considered to be illustrative and not restrictive.

What is claimed is:

1. A mobile communication device, comprising:
an RF circuit;
an antenna having a feed point coupled to the RF circuit by a transmission line; and
a tank circuit, including an inductor and a capacitor connected in parallel between the transmission line and an RF ground,
wherein the antenna and tank circuit together comprise a matched antenna with two resonant frequencies.

2. The mobile communication device claimed in claim 1, wherein the antenna is a monopole radiator.

3. The mobile communication device claimed in claim 2, wherein the monopole radiator is a microstrip antenna, and wherein the feed point is the only feed point.

4. The mobile communication device claimed in claim 3, wherein the microstrip antenna includes a planar strip and a capacitive patch at an end of the planar strip opposite from the feed point.

5. The mobile communication device claimed in claim 4, wherein the planar strip and capacitive patch have an overall length of approximately 19 millimeters and the capacitive patch has a width of approximately 4.2 millimeters and a length of approximately 2.2 millimeters.

6. The mobile communication device claimed in claim 5, wherein the two resonant frequencies comprise frequencies approximately between 1.5-1.6 GHz and 2.4-2.5 GHz, respectively.

7. The mobile communication device claimed in claim 6, wherein the two resonant frequencies comprise 1.565 GHz and 2.45 GHz.

8. The mobile communication device claimed in claim 1, wherein the inductor has an approximate value of 1.3 nH and the capacitor has an approximate value of 2.2 pF.

9. The mobile communication device claimed in claim 1, wherein the antenna is printed upon a flexible substrate.

10. The mobile communication device claimed in claim 1, wherein the antenna in isolation has a wideband resonance that includes the two resonant frequencies.

11. The mobile communication device claimed in claim 10, wherein the tank circuit has a resonant frequency with the antenna in an open-circuit condition, and the tank circuit resonant frequency lies between the two resonant frequencies.

12. The mobile communication device claimed in claim 1, wherein the transmission line includes a signal trace.

13. A mobile communication device, comprising:
a memory;
a processor;
an RF transceiver for sending and receiving RF modulated communications;
an antenna having a feed point coupled to the RF circuit by a transmission line; and
a tank circuit, including an inductor and a capacitor connected in parallel between the transmission line and an RF ground,
wherein the antenna and tank circuit together comprise a matched antenna with two resonant frequencies,
and wherein the antenna comprises a monopole microstrip antenna having a wideband frequency response in isolation, the wideband frequency response including the two resonant frequencies,
and wherein the tank circuit and RF circuit have a resonant frequency between the two resonant frequencies when the antenna is open-circuited.

14. The mobile communication device claimed in claim 13, wherein the microstrip antenna includes a planar strip and a capacitive patch at an end of the planar strip opposite from the feed point.

15. The mobile communication device claimed in claim 14, wherein the planar strip and capacitive patch have an overall length of approximately 19 millimeters and the capacitive patch has a width of approximately 4.2 millimeters and a length of approximately 2.2 millimeters.

16. The mobile communication device claimed in claim 15, wherein the inductor has an approximate value of 1.3 nH and the capacitor has an approximate value of 2.2 pF.

17. The mobile communication device claimed in claim 16, wherein the two resonant frequencies comprise frequencies approximately between 1.5-1.6 GHz and 2.4-2.5 GHz, respectively.

18. The mobile communication device claimed in claim 17, wherein the two resonant frequencies comprise 1.565 GHz and 2.45 GHz.

19. The mobile communication device claimed in claim 13, wherein the antenna is printed upon a flexible substrate.

20. The mobile communication device claimed in claim 13, wherein the transmission line includes a signal trace.
